(19) United States
(12) Patent Application Publication
(10) Pub. No.: US 2025/0141637 A1
(43) Pub. Date: May 1, 2025

(54) SYSTEM AND METHOD FOR CROSS TECHNOLOGY RADIO FREQUENCY INTERFERENCE MITIGATION

(71) Applicant: GM Global Technology Operations LLC, Detroit, MI (US)

(72) Inventors: Kamran Ali, Troy, MI (US); Lakshmi V. Thanayankizil, Troy, MI (US)

(21) Appl. No.: 18/494,102

(22) Filed: Oct. 25, 2023

(51) Int. Cl. H04L 5/00; H04B 17/345

(52) U.S. Cl. CPC H04L 5/0073; H04B 17/345

(57) ABSTRACT

A method for cross-technology radiofrequency interference mitigation includes detecting an RF device that is within a predetermined distance from a vehicle. The vehicle includes a plurality of wireless communication chipsets, each of the plurality of wireless communication chipsets is configured to wirelessly transmit and receive data. The method further includes determining that signals transmitted by the RF device is causing radiofrequency interference to signals transmitted by the plurality of wireless communication chipsets of the vehicle. Further, method includes commanding at least one of the plurality of wireless communication chipsets or the RF device to perform a control action to minimize the radiofrequency interference in response to determining that the that the signals transmitted by the RF device is causing radiofrequency interference to signals transmitted by the plurality of wireless communication chipsets of the vehicle.

### INTRODUCTION

The present disclosure relates to a system and method for cross technology radio frequency (RF) interference mitigation.

This introduction generally presents the context of the disclosure. Work of the presently named inventors, to the extent it is described in this introduction, as well as aspects of the description that may not otherwise qualify as prior art at the time of filing, are neither expressly nor impliedly admitted as prior art against this disclosure.

Several wireless technologies do not have much room to adapt to the channel condition (e.g., UWB, V2X, etc.). RF interference may significantly impact their operation (e.g., communication range, localization accuracy, communication throughput, etc.). If an RF device is not connected to a vehicle, that vehicle cannot control the wireless signals (which may cause RF interference) of the RF device that is brought into the vehicle. It is therefore desirable to develop a system and method for cross-technology radio frequency (RF) interference mitigation.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method for cross-technology radiofrequency (RF) interference mitigation. In general, RF interference may be caused by multiple undetectable sources. The presently disclosed method is useful if the system knows which RF device (that's connected to the vehicle) the interference is coming from. Then, the system adapts (e.g., by moving that RF device to a different frequency band, etc.). In the present disclosure, the term “RF device” means an electronic-electrical product device capable of emitting radiofrequency by radiation, conduction, or other means. The method includes detecting an RF device, such as a mobile phone or other mobile device, that is within a predetermined distance from a vehicle. The vehicle includes a plurality of wireless communication chipsets. Each of the plurality of wireless communication chipsets is configured to wirelessly transmit and receive data; determining that signals transmitted by the RF device are causing radiofrequency interference to signals transmitted by the plurality of wireless communication chipsets of the vehicle. The method further includes, in response to determining that the that the signals transmitted by the RF device is causing radiofrequency interference to signals transmitted by the plurality of wireless communication chipsets of the vehicle, commanding at least one of the plurality of wireless communication chipsets or the RF device to perform a control action to minimize the radiofrequency interference. Other embodiments of this aspect include corresponding computer systems, apparatus, and computer programs recorded on one or more computer storage devices, each configured to perform the actions of the methods. The method described in this paragraph improves vehicle technology by minimizing RF interference between an RF device and the wireless communication chipsets in the vehicle.

Implementations may include one or more of the following features. The method where the control action includes changing the channel of operation of the RF device. The control action includes chaining a channel of operation of at least one of the plurality of wireless chipsets. The control action includes increasing the electrical power transmitted to the RF device. The control action includes increasing an electrical power supplied to the at least one of the plurality of wireless chipsets. The method may include determining a channel mapping distribution among the plurality of wireless communication chipsets of the vehicle and the RF device. The method may include updating a plurality of channels of operation of the plurality of wireless communication chipsets of the vehicle and the RF device according to the channel mapping distribution. The method may include determining a signal-to-noise ratio (SNR) of at least one of the plurality of wireless communication chipset to determine whether the signals transmitted by the RF device, such as RF device, are causing the radiofrequency interference to signals transmitted by the plurality of wireless chipsets of the vehicle. The method may include comparing the SNR of the at least one of the plurality of wireless communication chipset with a predetermined SNR threshold to determine whether the SNR of the RF device is less than the predetermined snr threshold and determining that the SNR of the at least one of the plurality of wireless communication chipset is less than the predetermined snr threshold. The control action is performed solely in response to determining that the SNR of the RF device is less than the predetermined snr threshold. Implementations of the described techniques may include hardware, a method or process, or computer software on a computer-accessible medium.

One general aspect includes a system for cross-technology radiofrequency interference mitigation. The system also includes a vehicle including a controller and a plurality of wireless communication chipsets in communication with the controller; where the controller is programmed to execute the method described above. Other embodiments of this aspect include corresponding computer systems, apparatus, and computer programs recorded on one or more computer storage devices, each configured to perform the actions of the methods.

Further areas of applicability of the present disclosure will become apparent from the detailed description provided below. It should be understood that the detailed description and specific examples are intended for purposes of illustration only and are not intended to limit the scope of the disclosure.

The above features and advantages, and other features and advantages, of the presently disclosed system and method are readily apparent from the detailed description, including the claims, and exemplary embodiments when taken in connection with the accompanying drawings.

### BRIEF DESCRIPTION OF THE DRAWINGS

The present disclosure will become more fully understood from the detailed description and the accompanying drawings, wherein:

FIG. 1 is a block diagram of a vehicle including a system for cross technology radio frequency (RF) interference mitigation.

FIG. 2 is a flowchart of a method for cross technology radio frequency (RF) interference mitigation.

### DETAILED DESCRIPTION

Reference will now be made in detail to several examples of the disclosure that are illustrated in accompanying drawings. Whenever possible, the same or similar reference numerals are used in the drawings and the description to refer to the same or like parts or steps.

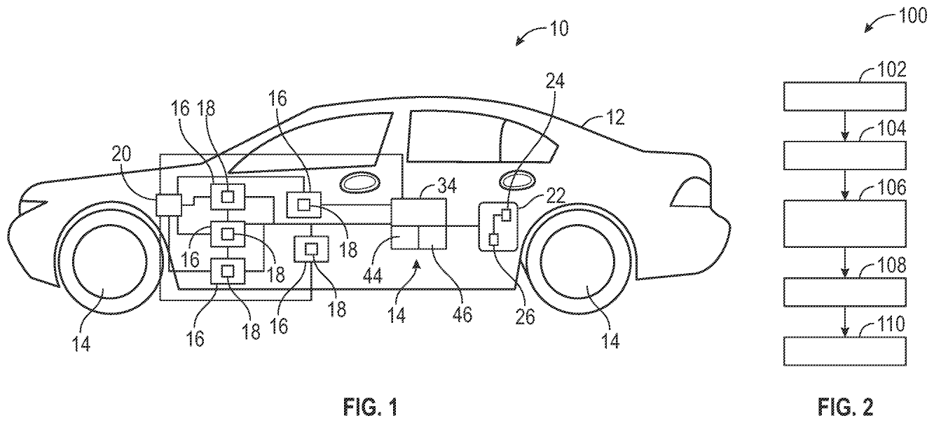

With reference to FIG. 1, a vehicle 10 generally includes a body 12 and a plurality of wheels coupled to the body 12. The vehicle 10 may be an autonomous vehicle. In the depicted embodiment, the vehicle 10 is depicted in the illustrated embodiment as a sedan, but it should be appreciated that other vehicles including trucks, coupes, sport utility vehicles (SUVs), recreational vehicles (RVs), etc., may also be used.

A system 14 may be part or work together with the vehicle 10. The system 14 may be referred to as a system for cross technology radio frequency (RF) interference and may include a controller 34. The controller 34 includes at least one processor 44 and a non-transitory computer readable storage device or media 46. The processor 44 may be a custom made or commercially available processor, a central processing unit (CPU), a graphics processing unit (GPU), an auxiliary processor among several processors associated with the vehicle controller 34, a semiconductor-based microprocessor (in the form of a microchip or chip set), a macroprocessor, a combination thereof, or generally a device for executing instructions. The computer readable storage device or media 46 may include volatile and nonvolatile storage in read-only memory (ROM), random-access memory (RAM), and keep-alive memory (KAM), for example. KAM is a persistent or nonvolatile memory that may be used to store various operating variables while the processor 44 is powered down. The computer-readable storage device or media 46 may be implemented using a number of memory devices such as PROMs (programmable read-only memory), EPROMs (electrically PROM), EEPROMs (electrically erasable PROM), flash memory, or another electric, magnetic, optical, or combination memory devices capable of storing data, some of which represent executable instructions, used by the controller 34 in controlling the vehicle 10. The controller 34 of the vehicle 10 may be referred to as a vehicle controller and may be programmed to execute a method 100 (FIG. 2) as described in detail below.

The instructions may include one or more separate programs, each of which comprises an ordered listing of executable instructions for implementing logical functions. The instructions, when executed by the processor 44, receive and process signals from sensors, perform logic, calculations, methods and/or algorithms for automatically controlling the components of the vehicle 10, and generate control signals to automatically control the components of the vehicle 10 based on the logic, calculations, methods, and/or algorithms. Although a single controller 34 is shown in FIG. 1, embodiments of the vehicle 10 may include a plurality of controllers 34 that communicate over a suitable communication medium or a combination of communication mediums and that cooperate to process the sensor signals, perform logic, calculations, methods, and/or algorithms, and generate control signals to automatically control features of the vehicle 10.

The vehicle 10 further includes a plurality of wireless communication chipsets 16 each in communication with the controller 34. The term “chipset” means a collection of integrated circuits that form the set needed to make an electronic device. The term “wireless communication chipset” means a chipset configured to 16 to wirelessly communicate data to and from other remote entities, such as a mobile phone. The controller 34 may control the operation of each of the wireless communication chipsets 16. Each wireless communication chipset 16 includes a vehicle transceiver 18 disposed inside the vehicle 10. The vehicle transceivers 37 are configured for receiving and/or transmitting signals.

The wireless communication chipsets 16 are configured to communicate using different wireless technology standards. As a non-limiting example, one or more wireless communication chipsets 16 may use Dedicated Short-Range Communication (DSRC) standard to send and receive Vehicle-to-Vehicle communications (V2X communications). DSRC channels refer to one-way or two-way short-range to medium-range wireless communication channels specifically designed for automotive use and a corresponding set of protocols and standards. Other wireless communication chipsets 16 may be configured to communicate WI-FI™. In other words, these wireless communication chipsets 16 transmit and receive via a wireless local area network (WLAN) using IEEE 802.11 standards. Another wireless communication chipset 16 may use ultra-wideband (UWB) technology to transmit and receive signals. UWB is a radio technology that can use a very low energy level for short-range, high-bandwidth communications over a large portion of the radio spectrum. Another wireless communication chipsets 16 uses BLUETOOTH® technology to transmit and receive signals. BLUETOOTH® technology is a short-range wireless technology standard that is used for exchanging data between fixed and RF devices over short distances and building personal area networks (PANs). Another wireless communication chipsets 16 uses LONG-TERM EVOLUTION (LTE™) to transmit and receive signals. LTE™ is a standard for wireless broadband communication for RF devices and data terminals, based on the GSM/EDGE and UMTS/HSPA standards. Another wireless communication chipsets 16 uses the 5G™ technology standard to transmit and receive signals. The 5G™ technology standard is the fifth-generation technology standard for cellular networks.

The vehicle 10 further includes one or more vehicle power supplies 20 electrically connected to one or more of the wireless communication chipsets 16. The vehicle power supply 20 is configured to supply electrical power to the wireless communication chipsets 16. The controller 34 is in communication with the vehicle power supply 20. Accordingly, the controller 34 may control the operation of the vehicle power supply 20.

As shown in FIG. 1, an RF device 22 may be in wireless communication with the controller 34 and may be a mobile device. The term “RF device” means an electronic-electrical product device capable of emitting radiofrequency by radiation, conduction, or other means. The term “mobile device” means a computer, small enough to hold and operate in the hand. As non-limiting examples, the mobile device may be a smartphone or a tablet. The RF device 22 is not physically connected to the vehicle 10 and may therefore be removed from the vehicle 10. In the depicted embodiment, the RF device 22 includes a device power supply 24 and a device transceiver 26. electrically connected to the device power supply 24. The device transceiver 26 is configured to transmit and receive wireless signals. The device power supply 23 is configured to supply electrical power to the device transceiver 26.

The system 14 is configured for cross technology radio frequency (RF) interference mitigation. Several wireless technologies do not have much room to adapt to the channel condition (e.g., UWB, V2X, etc.). RF interference may significantly impact their operation (e.g., communication range, localization accuracy, etc.). Currently, the vehicle 10 cannot control the wireless signals (which may cause RF interference) of an RF device 22 that is brought into the vehicle 10. It is therefore desirable to develop the system 14, which mitigates RF interference. The system 14 determines if the RF device 22 will create significant RF interference to one or more of the wireless communication chipsets 16. If the RF interference is significant enough, the system 14 takes measures to reduce that RF interference by making changes on the vehicle side or the RF device side. The system 14 also includes context aware algorithms and coordination between multiple wireless technologies to take real-time countermeasures for reducing the impact of RF interference.

As an example, UWB signals are a very low energy level for short-range, high-bandwidth signals (e.g., 500 MHZ). Several UWB devices operate in channels that overlap with WIFI channels (e.g., 2.4 GHz and 5 GHZ). Moreover, with the 6 GHz spectrum opening, the WIFI-6E transmissions may pose a serious threat for UWB-based systems given that WIFI transmission have much higher power than UWB devices. Further, UWB devices do not have the capability to perform energy detection-based channel occupancy determination. Thus, existing RF interference mitigation techniques cannot be applied directly to UWB systems. Hence, WIFI transmissions may impact both communication and ranging capabilities. This may potentially impact several UWB use-cases that operate when the vehicle passengers are inside the vehicle 10 (e.g., in-vehicle localization). The system 14 may change the channel of operation of the WIFI chipset to allow an imparting transmission first and may then go back to the previous channel. When the UWB device is turned on and performing localization, the in vehicle WIFI determines the maximum noise level it can handle to the key performance indicators (KPIs) for the localization feature. The WIFI module in the vehicle 10 constantly monitors the channels used by the UWB device and estimates the RF interference to it by the RF device 22. To do so, the noise level of the RF device 22 on the UWB receiver may be estimated. If the noise level exceeds what is allowed to meet the localization KPIs, then the in-vehicle WIFI chipset notifies the RF device 22 to move to a different channel. The in-vehicle WIFI chipset identifies the most optical channel for the RF device 22 (i.e., the channel that has the minimal impact to all features in the vehicle 10). When the controller 34 asks the RF device 22 to move away from a channel, the controller 34 should not ask the RF device 22 to move to a channel that impacts another wireless communication chipset 16. Instead, a list of channels that are least intrusive to the wireless communication chipsets 16 are broadcasted in the beacon.

As an example, both 5 GHz and 6 GHZ WIFI technologies operate on channels adjacent to the 5.9 GHz channel of V2V technologies. Some channels may even overlap, causing co-channel interference. Out of band emissions (OOBE) of WIFI chipsets in the V2V channel may be quite high and impact the V2V range. OOBE from WIFI transmitters may raise the noise floor of the cellular V2X (C-V2X) receiver, which will result in lowering of the Signal-to-Interference plus noise ratio (SIRN) f=of the received cellular V2X packet. Moreover, compared to DSRC, cellular V2X uses a considerably different MAC protocol from WIFI technology. C-V2X transmitters sense and reserve the spectrum and once reserved, C-V2X devices transmit on the reserved resource without any further sensing. As a result, even if WIFI devices are already transmitting on the channel, C-V2X devices proceed with their transmissions, thereby potentially causing interference at the C-V2X receivers. Exiting mechanisms that provide a sufficient degree of protection to the C-2VX system do so at the cost of significant loss in WIFI throughput. Therefore, there is a need to design interference mitigation techniques for the C-V2X and WIFI technologies to coexist efficiently. The system 14 addresses these issues.

FIG. 2 is a flowchart of a method 100 for cross technology radio frequency (RF) interference mitigation. The method 100 begins at block 102. Block 102 is a training phase. At block 102, the controller 34 detects all the wireless communication chipsets 16 in the vehicle 10 and determines the required key performance indicators (e.g., quality of service metrics). Then, the method 100 continues to block 104. At block 104, the controller 34 scans for devices within a predetermined distance of the vehicle 10 (e.g., communication range). to detect the RF device 22. At block 102, the controller 34 may detect the RF device 22 that is within the predetermined distance of the vehicle 10. In response to detecting the RF device 22 within the predetermined distance of the vehicle 10, the method 100 proceeds to block 106.

At block 106, the controller 34 determining that the signals transmitted by the RF device 22 are causing radiofrequency interference to the signals transmitted by the wireless communication chipsets 16. Specifically, the controller 34 estimates the impact (i.e., radiofrequency interference) that the RF device 22 will have on each of the wireless communication chipsets 16. In response to determining that the RF device 22 will cause significant RF interference to one or more wireless communication chipsets 16, the controller 34 commands commanding one or more wireless communication chipsets 16 or the RF device 22 to perform a control action (i.e., corrective action) to minimize the radiofrequency interference. The control action may be changing the channel of operation of the RF device 22 or one more wireless communication chipsets 16 to minimize the radiofrequency interference. Alternatively, or additionally, the control action may be increasing or decreasing the electrical power supplied to the RF device 22 or one or more wireless communication chipsets 16 to minimize the radiofrequency interference.

As a non-limiting example, the controller 34 may determine a signal-to-noise ratio (SNR) of one or more wireless communication chipsets 16 to determine whether the signals transmitted by the RF device 22 are causing the radiofrequency interference to the signals transmitted by the wireless chipsets 16 of the vehicle 10. Then, the controller 34 compares the SNR of the wireless communication chipsets 16 with a predetermined SNR threshold. The control action (i.e., corrective action) may be performed solely in response to determining that the SNR of one or more wireless communication chipsets 16 is greater than the predetermined SNR threshold. Next, the method 100 continues to block 108.

At block 108, the controller 34 determines a channel mapping distribution among the wireless communication chipsets 16 of the vehicle 10 and the RF device 22. Further, the controller 34 notifies the wireless communication chipsets 16 of the vehicle and the RF device 22 about the channel mapping distribution. Next, the method 100 continues to block 110.

At block 110, the wireless communication chipsets 16 of the vehicle and/or the RF device 22 updates their respective channels of operation according to the previously determined channel mapping distribution, thereby minimizing RF interference.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the presently disclosed system and method that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

The drawings are in simplified form and are not to precise scale. For purposes of convenience and clarity only, directional terms such as top, bottom, left, right, up, over, above, below, beneath, rear, and front, may be used with respect to the drawings. These and similar directional terms are not to be construed to limit the scope of the disclosure in any manner.

Embodiments of the present disclosure are described herein. It is to be understood, however, that the disclosed embodiments are merely examples and other embodiments can take various and alternative forms. The figures are not necessarily to scale; some features could be exaggerated or minimized to display details of particular components. Therefore, specific structural and functional details disclosed herein are not to be interpreted as limiting, but merely as a representative basis for teaching one skilled in the art to variously employ the presently disclosed system and method. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Embodiments of the present disclosure may be described herein in terms of functional and/or logical block components and various processing steps. It should be appreciated that such block components may be realized by a number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with a number of systems, and that the systems described herein are merely exemplary embodiments of the present disclosure.

For the sake of brevity, techniques related to signal processing, data fusion, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that alternative or additional functional relationships or physical connections may be present in an embodiment of the present disclosure.

This description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims.

What is claimed is:

1. A method for cross-technology radiofrequency interference mitigation, comprising:
detecting that a RF device within a predetermined distance from a vehicle, wherein the vehicle includes a plurality of wireless communication chipsets, each of the plurality of wireless communication chipsets is configured to wirelessly transmit and receive data;
determining that signals transmitted by the RF device are causing radiofrequency interference to signals transmitted by the plurality of wireless communication chipsets of the vehicle; and
in response to determining that the that the signals transmitted by the RF device is causing radiofrequency interference to signals transmitted by the plurality of wireless communication chipsets of the vehicle, commanding at least one of the plurality of wireless communication chipsets or the RF device to perform a control action to minimize the radiofrequency interference.

2. The method of claim 1, wherein the control action includes changing a channel of operation of the RF device.

3. The method of claim 1, wherein the control action includes chaining a channel of operation of at least one of the plurality of wireless chipsets.

4. The method of claim 1, wherein the control action includes increasing an electrical power transmitted to the RF device.

5. The method of claim 1, wherein the control action includes increasing an electrical power transmitted to the at least one of the plurality of wireless chipsets.

6. The method of claim 1, further comprising determining a channel mapping distribution among the plurality of wireless communication chipsets of the vehicle and the RF device.

7. The method of claim 6, further comprising updating a plurality of channels of operation of the plurality of wireless communication chipsets of the vehicle and the RF device according to the channel mapping distribution.

8. The method of claim 7, further comprising determining a signal-to-noise ratio (SNR) of at least one of the plurality of wireless communication chipset to determine whether the signals transmitted by the RF device are causing the radiofrequency interference to signals transmitted by the plurality of wireless chipsets of the vehicle.

9. The method of claim 8, further comprising;
comparing the SNR of the at least one of the plurality of wireless communication chipset with a predetermined SNR threshold to determine whether the SNR of the RF device is less than the predetermined SNR threshold; and
determining that the SNR of the at least one of the plurality of wireless communication chipset is less than the predetermined SNR threshold.

10. The method of claim 9, wherein the control action is performed solely in response to determining that the SNR of the RF device is less than the predetermined SNR threshold.

11. A system for cross-technology radiofrequency interference mitigation, comprising:
a vehicle including a controller and a plurality of wireless communication chipsets in communication with the controller;
wherein the controller is programmed to:
detect that a RF device within a predetermined distance from the vehicle, wherein the vehicle includes a plurality of wireless communication chipsets, each of the plurality of wireless communication chipsets is configured to wirelessly transmit and receive data;
determine that signals transmitted by the RF device is causing radiofrequency interference to signals transmitted by the plurality of wireless chipsets of the vehicle; and
in response to determining that the that the signals transmitted by the RF device is causing radiofrequency interference to signals transmitted by the plurality of wireless chipsets of the vehicle, command at least one of the plurality of wireless communication chipsets or the RF device to perform a control action to minimize the radiofrequency interference.

12. The system of claim 11, wherein the control action includes changing a channel of operation of the RF device.

13. The system of claim 11, wherein the control action includes chaining a channel of operation of at least one of the plurality of wireless chipsets.

14. The system of claim 11, wherein the control action includes increasing a power transmitted to the RF device.

15. The system of claim 11, wherein the control action includes increasing a power transmitted to the at least one of the plurality of wireless chipsets.

16. The system of claim 11, wherein the controller is programmed to determine a channel mapping distribution among the plurality of wireless communication chipsets of the vehicle and the RF device.

17. The system of claim 16, wherein the controller is programmed to update a plurality of channels of operation of the plurality of wireless communication chipsets of the vehicle and the RF device according to the channel mapping distribution.

18. The system of claim 17, wherein the controller is programmed to determine a signal-to-noise ratio (SNR) of at least one of the plurality of wireless communication chipsets of the vehicle to determine whether the signals transmitted by the RF device are causing radiofrequency interference to the signals transmitted by the plurality of wireless chipsets of the vehicle.

19. The system of claim 18, wherein the controller is programmed to:
compare the SNR of the at least one of the plurality of wireless communication chipsets with a predetermined SNR threshold to determine whether the SNR of the RF device is less than the predetermined SNR threshold; and
determine that the SNR of the RF device is less than the predetermined SNR threshold.

20. The system of claim 19, wherein the control action is performed solely in response to determining that the SNR of the RF device is less than the predetermined SNR threshold.
